(19) United States
(12) Patent Application Publication
(10) Pub. No.: US 2019/0053882 A1
(43) Pub. Date: Feb. 21, 2019

(54) Custom Abutments and Copings for Dental Restorations Used With Dental Implants and Processes for Their Fabrication

(71) Applicant: James R.Gildewell Dental Ceramlcs,Inc., Newport Beach, CA (US)

(72) Inventor: Vuong Thanh Le, Garden Grove, CA (US)

(21) Appl. No.: 15/998,760

(22) Filed: Aug. 16, 2018

Related U.S. Application Data
(60) Provisional application No. 62/546,264, filed on Aug. 16, 2017.

(51) Int. Cl. A61C 13/00; A61C 8/00; B33Y 10/00; B33Y 80/00; B23K 26/342

(52) U.S. Cl. CPC A61C 13/0019; A61C 13/0018; A61C 13/0004; B33Y 50/02; B33Y 10/00; B33Y 80/00; B23K 26/342; A61C 8/0054

(57) ABSTRACT

Methods using additive manufacturing processes for making custom abutments for dental implants and copings for screw retained crowns for dental implants are disclosed herein. The methods for making custom abutments include making a main body portion using an additive manufacturing system and adhesively attaching the main body portion to an insert member that extends into a central bore of the main body portion. The methods for making copings for screw retained crowns include making a coping using an additive manufacturing system, fusing a crown over the coping, and adhesively attaching the coping with crown to an insert member that extends into a central bore of the coping. Custom abutments and screw retained crowns made according to these methods are adapted to be attached onto dental implants previously installed in a patient's mouth.

### CROSS-REFERENCE

This application claims the benefit of and priority to U.S. Provisional Patent Application No. 62/546,264, filed Aug. 16, 2017, the entirety of which application is incorporated herein by reference.

### BACKGROUND

In the field of restorative dentistry, when a damaged or decayed tooth is removed, both the visible part of the tooth (i.e., the crown) and the tooth root are lost. In such a situation, a preferred way to replace the lost tooth is to use a dental implant, an implant abutment, and a restorative crown. A dental implant is a cylindrical or tapered post, usually made of metal (e.g., titanium) or ceramic (e.g., zirconia) material, which serves as a substitute for the root of a natural tooth. An implant abutment is a connector that is placed on the top of the dental implant to connect the implant to a restoration, such as a crown, a bridge, or a denture. A restorative crown is a replacement for the visible part of the tooth (supragingival) that includes anatomical features, color, and shading to match the natural teeth.

Implant abutments are conventionally made of a variety of materials, such as titanium, surgical stainless steel, non-precious (NP) metal alloys, semi-precious (SP) metal alloys, precious (P) metal alloys, high noble (FIN) metal alloys, ceramic (e.g., zirconia), and the like. Custom implant abutments are typically fabricated by a dental laboratory based upon a physical impression or intraoral scan performed by a restorative dentist. The implant abutment is fabricated to resemble the emergence profile and shape of a natural tooth in order to support the gum tissue similar to the natural tooth. The implant abutment also includes an engagement portion that is configured to fit precisely onto the coronal end of the dental implant.

A conventional implant abutment fabrication technique is casting, in which a wax model of the implant abutment is formed, invested, and then cast using the lost-wax technique. One example of a casting fabrication process includes use of a universal clearance limited abutment (UCLA) which includes a machined metal cylinder with a plastic waxing sleeve attached. Alternatively, custom abutments can be milled or machined, in which a virtual model of the abutment is designed using a computer aided design (CAD) program, then a set of computer aided machining (CAM) instructions are created from the CAD file and used by a computer numerical control (CNC) machine (or mill) to fabricate the abutment via a subtractive manufacturing process. Other conventional implant abutment fabrication techniques are also known to those skilled in the art.

Several additive manufacturing processes have been developed and are suitable for manufacturing articles comprising many polymeric, ceramic, metal, and composite materials. As used herein, the term “additive manufacturing” generally refers to processes by which digital three-dimensional (3D) design data is used to build up a component in layers by depositing material. There are several categories of additive manufacturing processes, including vat photopolymerisation, material jetting, binder jetting, material extrusion (e.g., fuse deposition modelling (FDM)), powder bed fusion (e.g., direct metal laser sintering (DMLS), electron beam melting (EBM), selective heat sintering (SHS), selective laser melting (SLM), and selective laser sintering (SLS)), sheet lamination (e.g., ultrasonic additive manufacturing (UAM) and laminated object manufacturing (LOM)), and directed energy deposition.

Selective laser melting (SLM) is a known additive manufacturing process within the classification of powder bed fusion. Without intending to be limiting or comprehensive, SLM generally includes the following primary steps. First, a virtual three-dimensional model of an object is provided as a design file for the SLM system. The system then applies a layer of powdered material on a build platform, such as by using a roller or a blade. A portion of the powder is next solidified (e.g., fused) into a cross-section of the 3D model of the object via application of laser energy guided by design file of the object. The build platform is then lowered by a distance corresponding to a thickness of a layer of the object being fabricated, and the next layer of powder is applied. This layer-by-layer process is then repeated until the object is completed, after which all loose (non-solidified) powder is removed, leaving the completed part. As noted, this description of selective laser melting technology is not intended to be comprehensive, and those skilled in the art will recognize that these steps are illustrative and are not intended to be limiting because a full description of selective laser melting technology is beyond the scope of the present application.

Selective laser melting fabrication has been applied to the field of dental implant abutment fabrication. For example, in U.S. Pat. No. 8,778,443, there is described a method for manufacturing implant abutments wherein the implant abutment comprises a prefabricated base member for joining the implant abutment to the dental implant, and a customized main body portion formed by selective laser sintering and/or melting. In the described manufacturing method, the prefabricated base member is positioned on the build platform and the main body portion is formed by laser sintering and/or laser melting a titanium-containing powder directly onto the base member.

### SUMMARY

In a first aspect, a method for manufacturing a custom abutment for a dental implant restoration is provided. The custom abutment includes at least two parts that are attached to each other during the manufacturing process: a main body portion and a machined insert member. In an embodiment, the machined insert member comprises titanium alloy and includes a central body portion that extends into a central bore of the main body portion of the abutment, and an implant engagement portion. In an embodiment, the main body portion of the abutment is formed via an additive manufacturing process.

In a second aspect, a dental implant restoration includes a two-part custom abutment having a main body portion and a machined insert member. In an embodiment, the machined insert member comprises titanium alloy and includes a central body portion that extends into a central bore of the main body portion of the abutment, and an implant engagement portion. In an embodiment, the main body portion of the abutment is foil red via an additive manufacturing process.

In a third aspect, a method for manufacturing a coping for a screw retained crown is provided. The coping includes at least two parts that are attached to each other during the manufacturing process: a main body portion and a machined insert member. In an embodiment, the machined insert member comprises titanium alloy and includes a central body portion that extends into a central bore of the main body portion of the coping, and an implant engagement portion. In an embodiment, the main body portion of the coping is formed via an additive manufacturing process.

In a fourth aspect, a screw retained crown for a dental implant includes a two part coping having a main body portion and a machined insert member. In an embodiment, the machined insert member comprises titanium alloy and includes a central body portion that extends into a central bore of the main body portion of the coping, and an implant engagement portion. In an embodiment, the main body portion of the coping is formed via an additive manufacturing process.

In the methods described herein, the two-part structure of the custom abutments and copings provides several advantages over prior dental restoration components fabricated using additive manufacturing methods. One such advantage is that the portion of the abutment or coping that is designed to precisely engage the dental implant is not made to undergo any unnecessary heat treatments that might affect the dimensions of the engagement portion. Another such advantage is that the insert member that is attached to the main body portion of the abutment or coping is not made to undergo any unnecessary heat treatments that might affect the strength of the bond attaching the insert member to the main body portion due to any mismatch of the coefficient of thermal expansion (CTE) between the two members. Another such advantage is that the alignment between the final crown and the dental implant may be more carefully controlled. Yet another such advantage in certain embodiments is that the insert member, which engages the dental implant, is formed of a titanium material that is advantageously suited for engagement with most types of dental implants. Other and further advantages will be understood by reference to the descriptions that follow.

### BRIEF DESCRIPTION OF THE DRAWINGS

FIG. 1 is a screenshot of a computer aided design (CAD) program for designing a custom abutment for a dental implant.

FIG. 2 is a three-dimensional (3D) view of a design for a custom abutment for use in preparing instructions of an additive manufacturing system.

FIGS. 3 and 4 are perspective views of a custom abutment fabricated via an additive manufacturing process.

FIG. 5 is a perspective view of the custom abutment of FIGS. 3 and 4 after conducting finishing processes.

FIG. 6 is a perspective view of the custom abutment of FIG. 5 and a metal insert.

FIG. 7A is an exploded view and FIG. 7B a combined view of a crown and custom abutment installed on a dental implant analog via a screw.

FIG. 8 is a screenshot of a computer aided design (CAD) program for designing a coping for a screw retained crown for a dental implant.

FIG. 9 is a three-dimensional (3D) view of a design for a coping for use in preparing instructions of an additive manufacturing system.

FIGS. 10 and 11 are perspective views of a coping fabricated via an additive manufacturing process.

FIG. 12 is a perspective view of the coping of FIGS. 10 and 11 after conducting finishing processes.

FIG. 13 is a perspective view of the coping of FIG. 12 with an opaque applied to the exterior surfaces.

FIG. 14 is a perspective view of the coping of FIG. 13 with a wax up of a crown attached to the exterior surfaces.

FIG. 15 is a perspective view of a ceramic crown formed over the coping of FIG. 14 via a lost wax technique.

FIG. 16 is a perspective view of the ceramic crown and coping of FIG. 15 and a metal insert.

FIG. 17A is an exploded view and FIG. 17B a combined view of a screw retained crown installed on a dental implant analog via a screw.

FIG. 18 is a flowchart of a method for fabricating a custom abutment for a dental implant via an additive manufacturing process.

FIG. 19 is a flowchart of a method for fabricating a metal coping for a screw retained crown for a dental implant via an additive manufacturing process.

### DETAILED DESCRIPTION

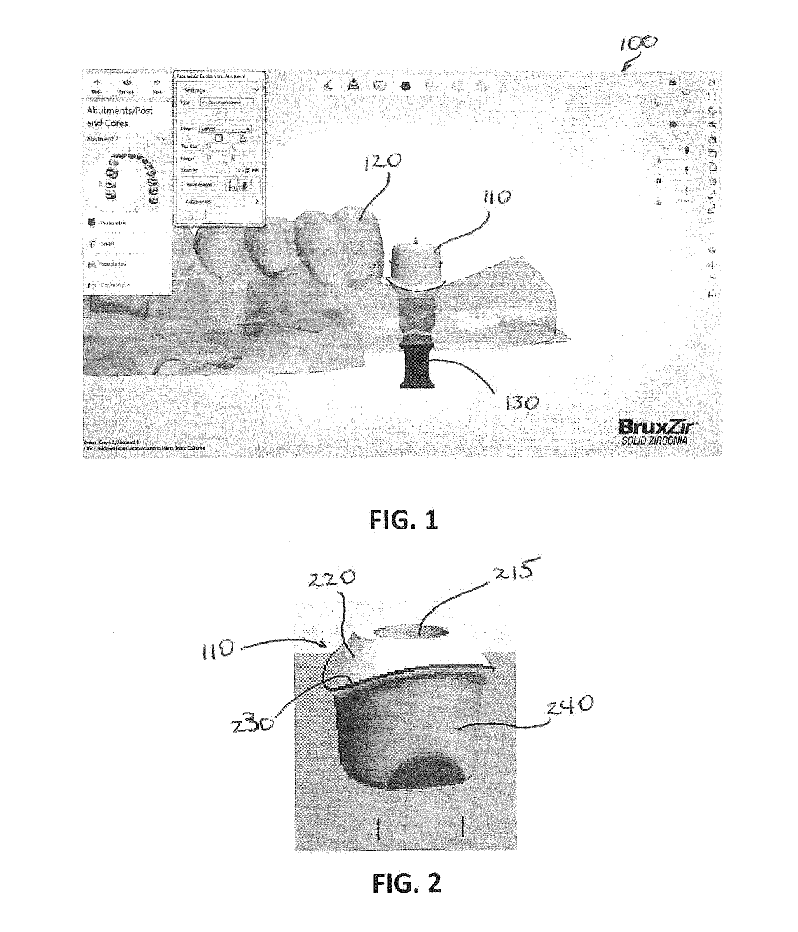

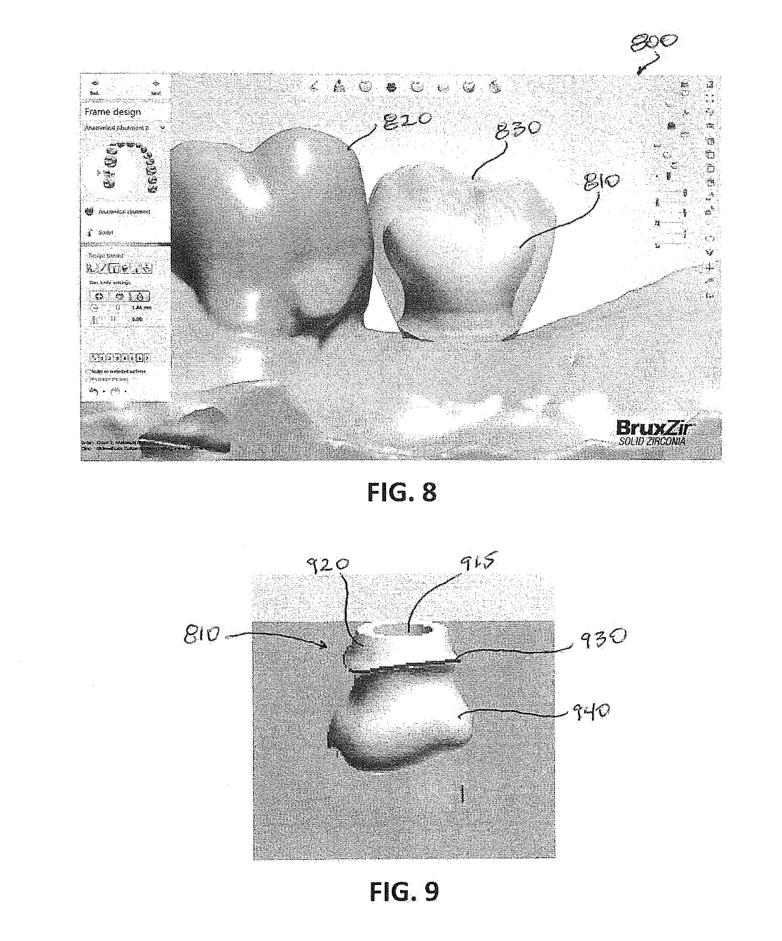

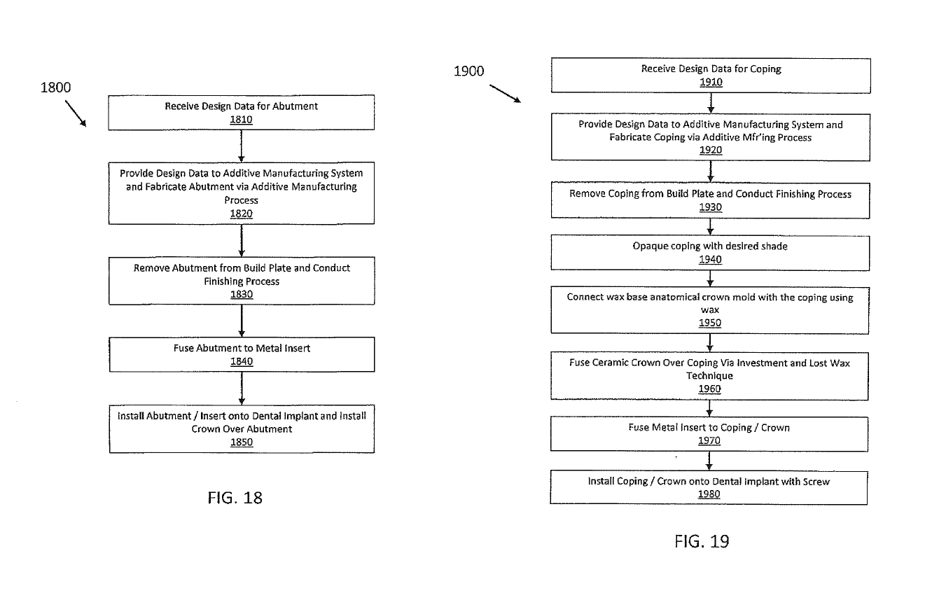

A method for making a custom abutment for a dental implant using an additive manufacturing process is exemplified in FIGS. 1-7 and in the flowchart shown in FIG. 18. A method for making a coping for a screw retained crown for a dental implant using an additive manufacturing process is exemplified in FIGS. 8-17 and in the flowchart shown in FIG. 19. These methods and articles made using these methods are described more fully below.

### Custom Abutment

Turning to the flowchart in FIG. 18, methods for making a custom abutment via an additive manufacturing process 1800 are described and illustrated. In a first step 1810, design data for a custom abutment is received by a user. In an embodiment, the design data is generated using computer aided design (CAD) software. FIG. 1 includes a screenshot 100 of a computer aided design software program used to design a 3D virtual custom abutment 110 for a dental implant restoration. The design software program includes the capability of displaying at least a portion of a representation of the patient's dentition 120 adjacent to the location of the dental implant. A virtual dental implant analog 130 is also displayed to represent the dental implant. The design software program includes tools for creating and changing the size, shape, and orientation of the abutment 110 in order to obtain a design suitable for the specific patient restoration needed. There are several commercially available design software programs that are suitable for performing the design of a custom abutment to be fabricated according to the methods described herein. For example, 3 Shape Implant Studio® dental design software (3 Shape A/S, Copenhagen, Denmark) may be used to design a custom abutment for a dental implant and to obtain a CAD design file that may be used in the fabrication processes described herein. Those skilled in the art will recognize that there are additional dental implant CAD software programs that are available and that are suitable for creating and providing a design file for a custom abutment.

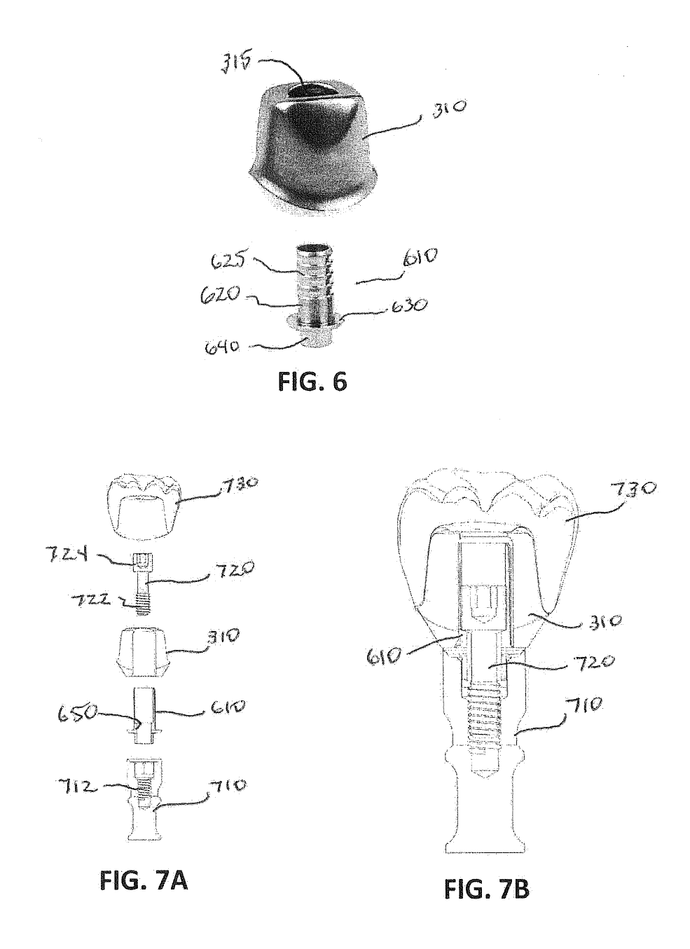

An example of a virtual (3D) representation of a design of a custom abutment 110 is shown in FIG. 2. The illustrated abutment 110 includes a central bore 215 to accommodate passage of an insert member and an attachment screw (see, e.g., FIGS. 6, 7A, and 7B). The lower end of the abutment 110 (viewed as the upper end in FIG. 2) includes an emergence profile 220 having a shape designed to match the contour of the gingival tissue surrounding the dental implant, and a margin line 230 defining the continual line of abutment-to-crown contact in the finished restoration. The remainder of the main body portion 240 of the abutment is designed to have a shape and size to support the crown and to optimize the hygiene and other functional aspects of the finished restoration.

As noted above, in some embodiments, the completed design of the abutment is in the form of a digital file that is suitable for use as an instruction for an additive manufacturing system. Returning to the flowchart in FIG. 18, in a subsequent step 1820, the abutment design data is provided to an additive manufacturing system and a custom abutment is fabricated using an additive manufacturing process. In an embodiment, the additive manufacturing system is a powder bed fusion system, such as a selective laser melting (SLM) system. The general mode of operation of selective laser melting systems is known in the art. Such systems typically include a vertically adjustable build platform upon which an article is fabricated. The SLM system also includes a source of laser energy located above the build platform and a computer-controlled guide for guiding the direction of the laser energy emitted from the source. Further, the SLM system also includes a roller or blade mechanism for uniformly distributing a powder containing the desired metal material one layer at a time as the build platform is lowered after melting of a given cross-section of the article. SLM systems suitable for fabricating abutments and other articles described herein include systems manufactured by Concept Laser, Inc. (Grapevine, Tex.), such as the LaserCUSING® model selective laser melting system.

In operation, the build platform of the SLM system is initially at its uppermost position, a first layer (e.g., from 10 μm to 100 μm thickness, or from 25 μm to 75 μm thickness, or from 35 μm to 65 μm thickness) of powdered metal material is distributed over the build platform, and laser energy is guided to heat the powdered metal by the guide pursuant to the instructions derived from the abutment design file. As a result, the layer of powdered metal is sintered only in the locations corresponding to the lowermost cross-section of the custom abutment. The build platform is then lowered a distance corresponding to the metal powder layer thickness (e.g., from 10 μm to 100 μm thickness, or from 25 μm to 75 μm thickness, or from 35 μm to 65 μm thickness), and the process is repeated to create subsequently higher cross-sections of the custom abutment until the entire abutment is completely formed on the build platform. Next, the loose metal powder is removed, leaving the completed abutment on the build platform.

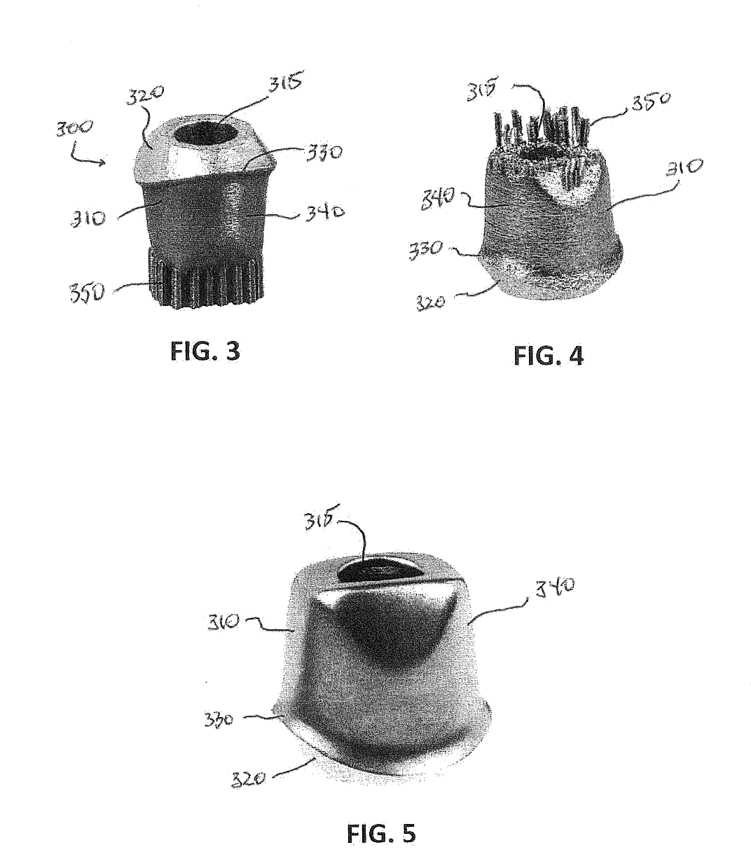

FIG. 3 shows an image of an article 300 formed according to the method described above. In the illustrated embodiment, the article formed using the SLM system includes a custom abutment 310 fabricated according to the design illustrated in FIG. 2. For example, the abutment 310 includes a central bore 315 to accommodate passage of an insert member and an attachment screw (as discussed more fully below in relation to FIGS. 6, 7A, and 7B), an emergence profile 320 having a shape designed to match the contour of the gingival tissue surrounding the dental implant, and a margin line 330 defining the continual line of abutment-to-crown contact in the finished restoration. The remainder of the main body portion 340 of the abutment is designed to have a shape and size to support the crown and to optimize the hygiene and other functional aspects of the finished restoration. Also shown in FIG. 3, the abutment 310 is supported by a plurality of support structures 350 formed to support the abutment portion on the build platform as it is formed by the SLM system. The support structures 350 serve to prevent sagging or shifting of the article.

The abutment 310 shown in FIG. 3 is formed using a metal-containing powder suitable for the selective laser melting system. Such metal-containing powders include those containing steel, titanium, aluminum, gold, cobalt, chrome, tungsten, silicon, palladium, platinum, silver, copper, zinc, tin, indium, gallium, manganese, iron, and alloy mixtures of two or more of the foregoing materials. Suitable metal-containing powders are characterized as non-precious (NP), semi-precious (SP), noble (N), and high noble (HN). Several suitable selective laser melting materials are commercially available, including, for example, SLM High Noble, SLM Noble 25, and SLM Non-Precious available from Argen Corp. (San Diego, Calif.), and Remanium® Star CL laser melting powder available from Dentaurum GmbH & Co. KG (Ispringen, Germany).

As noted above, the abutment 310 shown in FIG. 3 includes a plurality of support structures 350 formed during the fabrication of the abutment 310 by the selective laser melting system. Turning to FIG. 4, and also referring to step 1830 of the flowchart shown in FIG. 18, after the abutment 310 is removed from the build platform of the SLM system, a metal-finishing step is performed during which the support structures 350 are removed. Once the support structure 350 are removed, as shown in FIG. 5, the abutment 310 is polished in order to provide a high shine polish capable of inhibiting bacteria build up in the patient's mouth.

Next, and in reference to step 1840 of the flowchart in FIG. 18, in FIG. 6 there is shown an abutment 310 and an insert member 610, a portion of which is configured to be inserted into the central bore 315 of the abutment 310. In the embodiment shown in FIG. 6, the insert member 610 includes a central body portion 620, a flange 630, and an implant engagement portion 640. The central body portion 620 includes a plurality of ridges 625 formed on the exterior surface to enhance bonding to the interior surface of the central bore 315 of the abutment, as described more fully below. The height of the central body portion 620 is preferably approximately the length of the central bore 315 of the abutment such that the central body portion 620 occupies the full length of the central bore 315 once installed. The flange 630 is configured to engage and bond to the lower, gingival surface of the abutment 310 immediately adjacent to the central bore 315. The implant engagement portion 640 is configured to engage a reciprocal engagement portion on the coronal surface of the implant. Typical implant engagement portion 640 configurations include hexagonal, multi-lobe, or other anti-rotation configurations known to those skilled in the art. The insert member 610 is preferably formed of a titanium alloy (e.g., Grade 23—Titanium 6Al-4V) and is machined to a size and orientation suitable for engaging the abutment 310 and the reciprocal engagement portion of the dental implant to which it is to be attached.

To complete the process of preparing the abutment for installation onto a dental implant, the insert member 610 is installed into the central bore 315 of the abutment 310. This is accomplished by first applying an adhesive material, such as a cement, to the interface between the central body portion 620 of the insert member and the central bore 315 of the abutment. In some embodiments, the adhesive material is a self-curing cement such as Panavia™ cement (Kuraray America, New York, N.Y.) or MonoCem™ self-adhesive cement (Shofu Dental Corporation, San Marcos, Calif.). The insert member 610 is then inserted into the central bore 315 and any extra adhesive material is removed prior to curing.

It is important during the insertion step to obtain a proper alignment of the engagement portion 640 of the insert member relative to the abutment 310 so that the abutment 310 is also in the proper alignment when the abutment is installed onto the dental implant. In several embodiments, this is achieved by providing an indexing interface between the abutment 310 and the insert member 610. Examples of indexing interfaces include mating flat surfaces, mating curved surfaces, mating tab and groove surfaces, and similar constructions known to those skilled in the art. In an embodiment, an indexing interface is achieved by providing a flat portion on the central body 620 of the insert member that is configured to mate with a flat surface that is designed and built into the central bore 315 of the abutment. The interaction of the indexing interface allows the insert member 610 to be placed into the central bore 315 of the abutment in only a single orientation corresponding to the desired design, thereby providing proper alignment of the finished restoration on the dental implant.

Once assembled, the abutment 310 and insert member 610 comprise an integrated abutment that may be installed onto a dental implant, as referenced by step 1850 in FIG. 18. For example, FIGS. 7A and 7B show the abutment 310 and insert member 610 being retained on a dental implant analog 710 by a screw 720. The screw 720 includes a threaded portion 722 at a distal end and head portion 724 at a proximal end. The threaded portion 722 is configured to engage mating threads 712 on the internal bore of the dental implant analog 710 (or a dental implant). The head portion 724 is configured to engage a shoulder region 650 on the interior of the insert member 610, thereby retaining the insert member 610 (and the attached abutment 310) on the dental implant analog 710 when the threaded portion 722 of the screw is engaged with the mating threads 712 of the dental implant analog 710 (or a dental implant). Once the integrated abutment 310 and insert member 610 are installed onto the dental implant, a crown 730 may be installed to complete the restoration in a manner known to those skilled in the art.

In the embodiments described above, the main body portion of the abutment 310 is fabricated using an additive manufacturing process. In alternative embodiments, the main body portion of the abutment 310 can be fabricated using a subtractive manufacturing process, such as milling or machining, using a computer numerical control (CNC) milling machine. In the alternative embodiments, the digital file containing the completed design of the abutment is provided for use as an instruction for a CNC milling machine that is used to fabricate the main body portion of the abutment 310. The main body portion of the abutment 310 is then combined with an insert member 610 in the same manner described above to form an integrated abutment 310, which is then used to form a completed restoration.

### Screw Retained Crown

Turning to the flowchart in FIG. 19, methods for making a coping for a screw retained crown via an additive manufacturing process 1900 are described and illustrated. In a first step 1910, design data for a coping for a screw retained crown is received by a user. In an embodiment, the design data is generated using computer aided design (CAD) software. FIG. 8 includes a screenshot 800 of a computer aided design software program used to design a 3D virtual coping 810 for a screw retained crown dental implant restoration. The design software program includes the capability of displaying at least a portion of a representation of the patient's dentition 820 adjacent to the location of the dental implant, and for displaying and designing the crown portion 830 of the screw retained crown restoration. The design software program includes tools for creating and changing the size, shape, and orientation of the coping 810 in order to obtain a design suitable for the specific patient restoration needed. There are several commercially available design software programs that are suitable for performing the design of a coping and screw retained crown to be fabricated according to the methods described herein. For example, 3 Shape Implant Studio® dental design software (3 Shape A/S, Copenhagen, Denmark) may be used to design a custom coping for a screw retained crown for a dental implant and to obtain a CAD design file that may be used in the fabrication processes described herein. Those skilled in the art will recognize that there are additional dental implant CAD software programs that are available and that are suitable for creating and providing a design file for a coping for a screw retained crown.

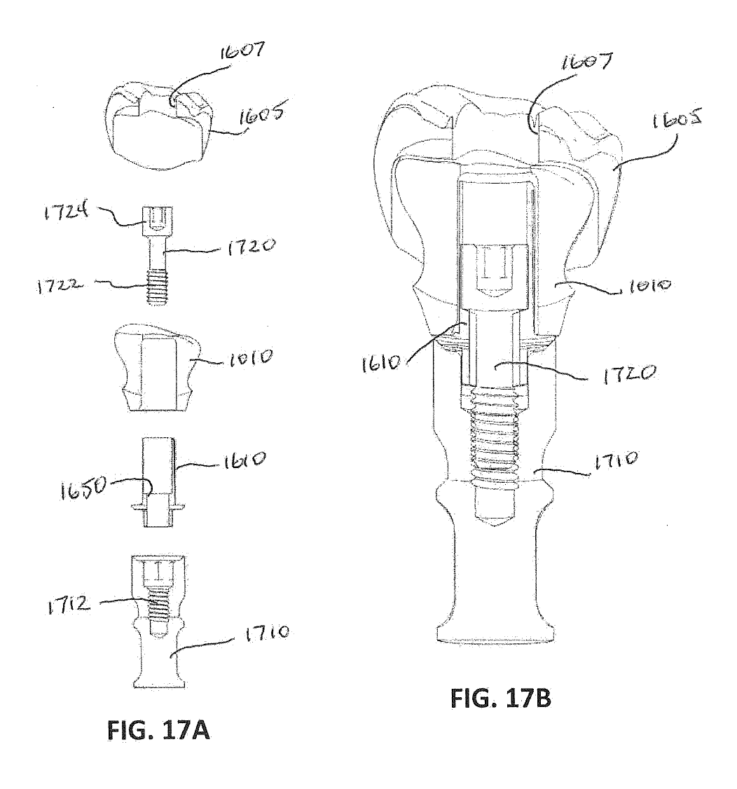

An example of a virtual (3D) representation of a design of a coping 810 is shown in FIG. 9. The illustrated coping 810 includes a central bore 815 to accommodate passage of an insert member and an attachment screw (see, e.g., FIGS. 16, 17A, and 17B). The lower end of the coping 810 (viewed as the upper end in FIG. 9) includes an emergence profile 920 having a shape designed to match the contour of the gingival tissue surrounding the dental implant, and a margin line 930 defining the continual line of coping-to-crown contact in the finished restoration. The remainder of the main body portion 940 of the coping is designed to have a shape and size to support the crown and to optimize the hygiene and other functional aspects of the finished restoration.

As noted above, the completed design of the coping is in the form of a digital file that is suitable for use as an instruction for an additive manufacturing system. Returning to the flowchart in FIG. 19, in a subsequent step 1920, the coping design data is provided to an additive manufacturing system and a coping for a screw retained crown is fabricated using an additive manufacturing process. In an embodiment, the additive manufacturing system is a powder bed fusion system, such as a selective laser melting (SLM) system. The general mode of operation of selective laser melting systems is known in the art, is described more fully above, and will not be repeated here.

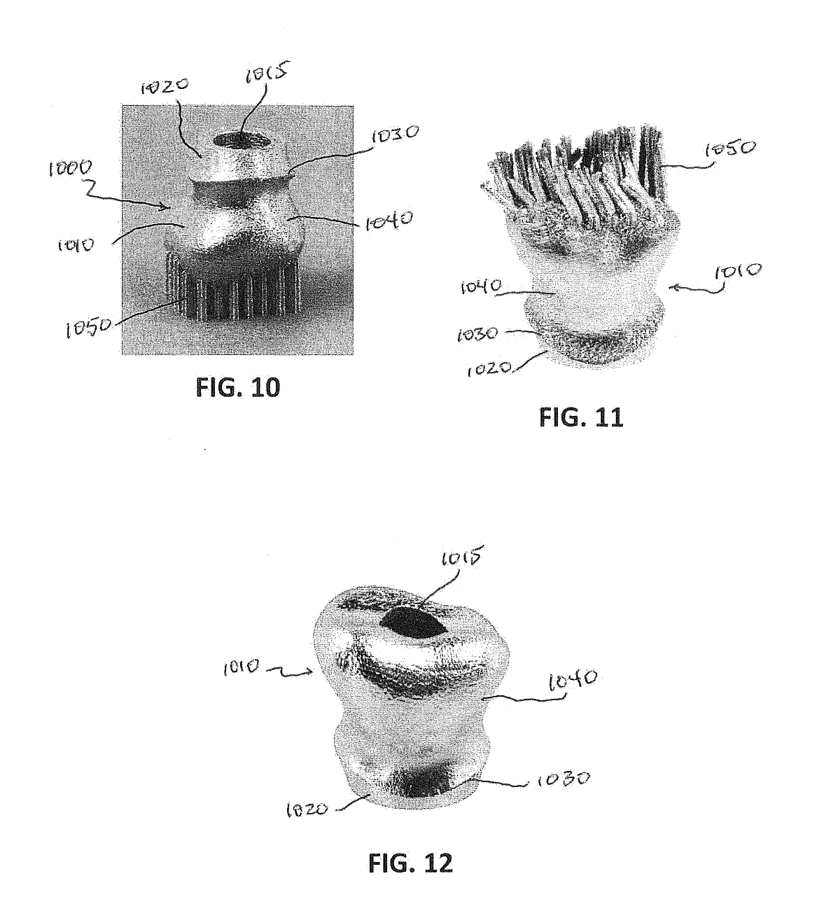

FIG. 10 shows an image of an article 1000 formed using a suitable SLM system. In the illustrated embodiment, the article formed using the SLM system includes a custom coping 1010 fabricated according to the design illustrated in FIG. 9. For example, the coping 1010 includes a central bore 1015 to accommodate passage of an insert member and an attachment screw (as discussed more fully below in relation to FIGS. 16, 17A, and 17B), an emergence profile 1020 having a shape designed to match the contour of the gingival tissue surrounding the dental implant, and a margin line 1030 defining the continual line of coping-to-crown contact in the finished restoration. The remainder of the main body portion 1040 of the coping is designed to have a shape and size to support the crown and to optimize the hygiene and other functional aspects of the finished restoration. Also shown in FIG. 10, the coping 1010 is supported by a plurality of support structures 1050 formed to support the coping portion on the build platform as it is formed by the SLM system. The support structures 1050 serve to prevent sagging or shifting of the article.

The coping 1010 shown in FIG. 10 is forming using a metal-containing powder suitable for the selective laser melting system. Such metal-containing powders include those containing steel, titanium, aluminum, gold, cobalt, chrome, tungsten, silicon, palladium, platinum, silver, copper, zinc, tin, indium, gallium, manganese, iron, and alloy mixtures of two or more of the foregoing materials. Suitable metal-containing powders are characterized as non-precious (NP), semi-precious (SP), noble (N), and high noble (HN). Several suitable selective laser melting materials are commercially available, including, for example, SLM High Noble, SLM Noble 25, and SLM Non-Precious available from Argen Corp. (San Diego, Calif.), and Remanium® Star CL laser melting powder available from Dentaurum GmbH & Co. KG (Ispringen, Germany).

As noted above, the coping 1010 shown in FIG. 10 includes a plurality of support structures 1050 formed during the fabrication of the coping 1010 by the selective laser melting system. Turning to FIG. 11, and also referring to step 1930 of the flowchart shown in FIG. 19, after the coping 1010 is removed from the build platform of the SLM system, a metal-finishing step is performed during which the support structures 1050 are removed. Once the support structures 1050 are removed, as shown in FIG. 12, the coping 1010 is provided with a finish to ensure mechanical retention for an opaque layer (discussed below) to have a strong bonding surface.

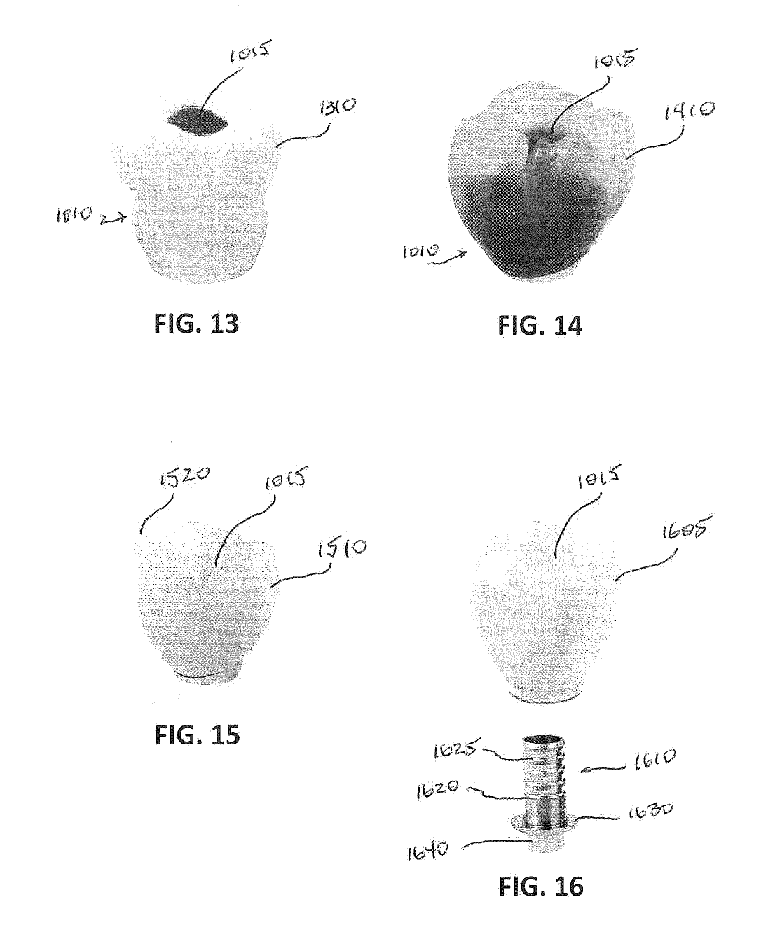

An opaque layer 1310 is next applied to the exterior surface of the coping 1010, as shown in FIG. 13 and as referenced in step 1940 of the flowchart in FIG. 19. The opaque layer 1310 includes a desired shade and serves to mask the metallic coloring of the underlying coping 1010. Next, in an embodiment, a wax model 1410 of the crown (pursuant to the design file) is attached to the coping 1010 (i.e., over the opaque layer 1310), as shown in FIG. 14 and as referenced in step 1950 of the flowchart in FIG. 19. The wax model 1410 is then sprued on a pressing ring and invested with investment material to cast a porcelain, ceramic, glass, or glass-ceramic crown in a manner known to those skilled in the art, as referenced in step 1960 of FIG. 19. FIG. 15 shows a glass-ceramic crown 1510 cast over the coping 1010, including a portion of the sprue 1520 prior to removal. The crown 1510 is then finished by removing any of the sprue 1520 remaining, and by applying any stain, glaze, or other aesthetic treatments needed. The crown 1510 then undergoes any necessary heat treatments in order to provide a completed finish.

Next, and in reference to step 1970 of the flowchart in FIG. 19, in FIG. 16 there is a finished crown 1605 and an insert member 1610, a portion of which is configured to be inserted into the central bore 1015 of the coping 1010 underlying the finished crown 1605. In the embodiment shown in FIG. 16, the insert member 1610 includes a central body portion 1620, a flange 1630, and an implant engagement portion 1640. The central body portion 1620 includes a plurality of ridges 1625 formed on the exterior surface to enhance bonding to the interior surface of the central bore 1015 of the coping 1010, as described more fully below. The height of the central body portion 1620 is preferably approximately the length of the central bore 1015 of the coping such that the central body portion 1620 occupies the full length of the central bore 1015 once installed. The flange 1630 is configured to engage and bond to the lower, gingival surface of the coping 1010 immediately adjacent to the central bore 1015. The implant engagement portion 1640 is configured to engage a reciprocal engagement portion on the coronal surface of the implant. Typical implant engagement portion 1640 configurations include hexagonal, multi-lobe, or other anti-rotation configurations known to those skilled in the art. The insert member 1610 is preferably formed of a titanium alloy (e.g., Grade 23—Titanium 6Al-4V) and is machined to a size and orientation suitable for engaging the coping 1010 and the reciprocal engagement portion of the dental implant to which it is to be attached.

To complete the process of preparing the screw retained crown for installation onto a dental implant, the insert member 1610 is installed into the central bore 1015 of the coping 1010. This is accomplished by first applying an adhesive material, such as a cement, to the interface between the central body portion 1620 of the insert member and the central bore 1015 of the abutment. In some embodiments, the adhesive material is a self-curing cement such as Panavia™ cement (Kuraray America, New York, N.Y.) or MonoCem™ self-adhesive cement (Shofu Dental Corporation, San Marcos, Calif.). The insert member 1610 is then inserted into the central bore 1015 and any extra adhesive material is removed prior to curing.

It is important during the insertion step to obtain a proper alignment of the engagement portion 1640 of the insert member relative to the coping 1010 so that the coping 1010 is also in the proper alignment when the abutment is installed onto the dental implant. In several embodiments, this is achieved by providing an indexing interface between the coping 1010 and the insert member 1610. Examples of indexing interfaces include mating flat surfaces, mating curved surfaces, mating tab and groove surfaces, and similar constructions known to those skilled in the art. In an embodiment, an indexing interface is achieved by providing a flat portion on the central body 1620 of the insert member that is configured to mate with a flat surface that is designed and built into the central bore 1015 of the coping. The interaction of the indexing interface allows the insert member 1610 to be placed into the central bore 1015 of the coping in only a single orientation corresponding to the desired design, thereby providing proper alignment of the finished restoration on the dental implant.

Once assembled, the coping 1010, insert member 1610, and crown 1605 comprise an integrated screw retained crown that may be installed onto a dental implant, pursuant to step 1980 of the flowchart in FIG. 19. For example, FIGS. 17A and 17B show the coping 1010 and insert member 1610 being retained on a dental implant analog 1710 by a screw 1720. The screw 1720 includes a threaded portion 1722 at a distal end and head portion 1724 at a proximal end. The threaded portion 1722 is configured to engage mating threads 1712 on the internal bore of the dental implant analog 1710 (or a dental implant). The head portion 1724 is configured to engage a shoulder region 1650 on the interior of the insert member 1610, thereby retaining the insert member 1610 (and the attached coping 1010) on the dental implant analog 1710 when the threaded portion 1722 of the screw is engaged with the mating threads 1712 of the dental implant analog 1710 (or a dental implant). Once the integrated coping 1010, insert member 1610, and crown 1605 are installed as a screw retained crown onto the dental implant, a the through hole 1607 in the crown may be sealed using a composite or other suitable material in a manner known to those skilled in the art.

In the embodiments described above, the main body portion of the coping 1010 is fabricated using an additive manufacturing process. In alternative embodiments, the main body portion of the coping 1010 can be fabricated using a subtractive manufacturing process, such as milling or machining, using a computer numerical control (CNC) milling machine. In the alternative embodiments, the digital file containing the completed design of the coping is provided for use as an instruction for a CNC milling machine that is used to fabricate the main body portion of the coping 1010. The main body portion of the coping 1010 is then combined with an insert member 1610 and a crown 1605 in the same manner described above to form a completed restoration.

The above description is included to illustrate the operation of the preferred embodiments and is not meant to limit the scope of the invention. The scope of the invention is to be limited only by the following claims. From the above discussion, many variations will be apparent to one skilled in the relevant art that would yet be encompassed by the spirit and scope of the invention.

What is claimed is:

1. A method for making a patient-specific abutment for a dental implant restoration, the method comprising:
using a computer-controlled additive manufacturing system to make a main body portion of an abutment according to a patient-specific design, an external surface of the main body portion defining a margin line and an emergence profile, an internal surface of the main body portion defining a central bore therethrough; and
adhesively attaching an insert member to the main body portion, the insert member having a central body portion being configured to extend into the central bore of the main body portion, and an implant engagement portion being configured to engage a reciprocal engagement portion of a dental implant.

2. The method of claim 1, wherein the additive manufacturing system comprises a powder bed fusion system having a mechanism for uniformly distributing a metal-containing powder, a source of laser energy, and a computer-controlled guide for guiding a direction of the laser energy emitted from the source.

3. The method of claim 1, wherein the central body portion of the insert member is generally cylindrical, having a plurality of ridges formed on an external surface.

4. The method of claim 1, wherein the central bore of the main body portion of the abutment includes a flat surface, and the central body portion of the insert member includes a flat portion configured to matingly engage the flat surface of the central bore, thereby providing an indexing interface between the main body portion and the insert member.
